(19) United States
(12) Patent Application Publication
(10) Pub. No.: US 2016/0085882 A1
(43) Pub. Date: Mar. 24, 2016

(54) BUILD ORIENTATIONS FOR ADDITIVE MANUFACTURING

(71) Applicant: Siemens Product Lifecycle Management Software Inc., Plano, TX (US)

(72) Inventors: Kang Li, Madison, WI (US); Suraj Ravi Musuvathy, Glenmont, NY (US); Edward Slavin, III, Robbinsville, NJ (US); Mark R. Burhop, Madison, AL (US); David Madeley, Lincolnshire (GB)

(21) Appl. No.: 14/604,278

(22) Filed: Jan. 23, 2015

Related U.S. Application Data
(60) Provisional application No. 62/052,756, filed on Sep. 19, 2014.

(51) Int. Cl. G06F 17/50; G06T 7/00

(52) U.S. Cl. CPC G06F 17/50; G06T 7/0046; G06T 2210/12

(57) ABSTRACT

Methods for product data management and corresponding systems and computer-readable mediums. A method includes receiving a solid model. The method includes analyzing the solid model to determine a suggested orientation that minimizes a build height or minimizes a support volume. The method includes displaying and saving the suggested orientation.

### CROSS-REFERENCE TO RELATED APPLICATION

This application claims the benefit of the filing date of U.S. Provisional Patent Application 62/052,756, filed Sep. 19, 2014, which is hereby incorporated by reference.

### TECHNICAL FIELD

The present disclosure is directed, in general, to computer-aided design (“CAD”), visualization, and manufacturing (“CAM”) systems, product lifecycle management (“PLM”) systems, and similar systems, that manage data and operations for products and other items (collectively, “Product Data Management” systems or PDM systems).

### BACKGROUND OF THE DISCLOSURE

PDM systems, and in particular CAD/CAM systems, can be used to design and produce products using additive manufacturing (“3D printing”) techniques. Improved systems are desirable.

### SUMMARY OF THE DISCLOSURE

Various disclosed embodiments include systems and methods for determining suitable object build orientations for additive manufacturing in a computer-aided design and manufacturing system. A method includes receiving a solid model; analyzing the solid model to determine orientations; modifying the orientations via an interaction with a user; and saving the orientations.

Another method includes receiving a solid model. The method includes analyzing the solid model to determine a suggested orientation that minimizes a build height or minimizes a support volume. The method includes displaying and saving the suggested orientation.

In some embodiments, the system also applies the orientations during a manufacturing process. In some embodiments, the system also generates candidate orientations. In some embodiments, the system also computes a support volume for each candidate orientation. In some embodiments, the system compares and sorts the support volumes for the candidate orientations and uses the candidate orientation with the least support volume as the suggested orientation that minimizes support volume. In some embodiments, the displayed suggested orientation has a minimum support volume among a pool of candidate orientations. In some embodiments, the system computes a bounding box of the solid model and uses an axis of the bounding box with a least length as the suggested orientation that minimizes build height.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates a process in accordance with disclosed embodiments;

FIGS. 3A-3C illustrate candidate orientation generation in accordance with disclosed embodiments;

FIGS. 4A-4C illustrate estimated support volume generation in accordance with disclosed embodiments; and

FIGS. 5A-5B illustrate a build orientation search dialog and an exemplary result output, respectively, in accordance with disclosed embodiments.

### DETAILED DESCRIPTION

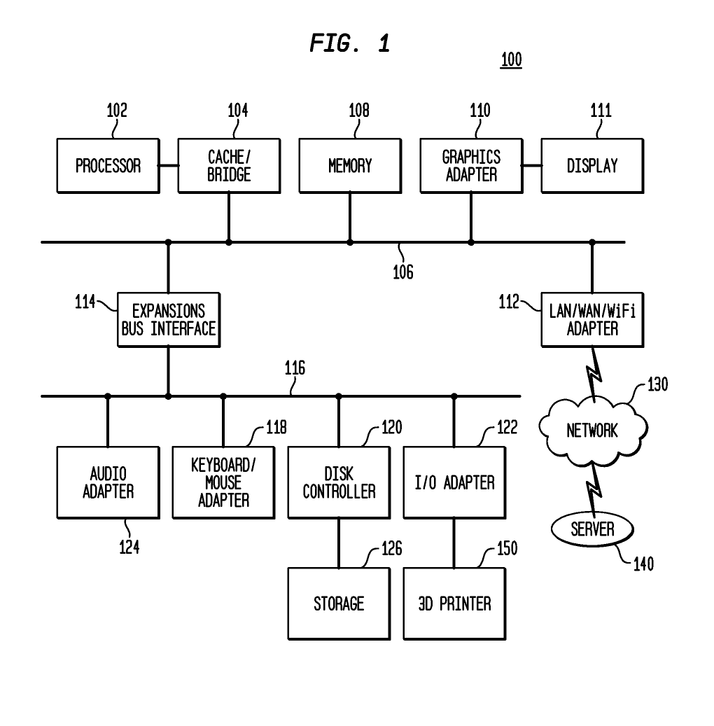

FIGS. 1 through 5B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Additive Manufacturing (AM), also known as 3D Printing, is a fabrication technique in which a part is built by additively depositing or binding material in layers, typically from the build plate up. Build orientation in additive manufacturing has significant influence on various aspects of manufactured model such as surface quality, build time, support structure cost, etc. In addition, the structural strength characteristics of a part and the dimensional accuracy of certain features such as holes in the part are known to be dependent on the build orientation.

Build orientation refers to the orientation of the part or product as it is being manufactured. Since 3D-printed parts are necessarily built from the “bottom” up, the orientation of the part changes which side is the “bottom” and therefore changes how the actual manufacturing process works. For example, during manufacture, structures of the part that have an “overhang” must be supported so that they can be correctly printed. This means that additional material is needed to form support structures during manufacture that will then be removed from the final part. This additional material, referred to herein as the “support volume” for the support structure, is wasted and is an additional but necessary expense during the manufacturing process. Depending on the build orientation, the shape of the part may require more or less support volume to enable correct printing. Disclosed embodiments can reduce cost by selecting a build orientation that minimizes the required support volume.

Further, different orientations may require more or less actual printing time (or “build time”) to ensure the part is correctly manufactured with all necessary support structures. The “taller” the part is, as measured from the build plate (the “bottom” in a specific orientation), the longer it will generally take to print the part. By minimizing the height of a part in a specific orientation, disclosed embodiments can reduce build time.

Determining an optimal build orientation therefore becomes an important problem so that one or more aspects of the part or the manufacturing process meet the users' manufacturing requirements. Managing the orientation within a CAD/CAM system is important for quality assurance purposes, and among other issues such as reducing workflow complexities.

Some CAD/CAM systems do not have sufficient functionality for determining and managing suitable build orientations for additive manufacturing of solid models. Solid models are typically exported into independent software packages for manufacturing. The solids can be first converted to polygonal meshes during the export or within the independent software packages, resulting in loss of accuracy, data translation issues, and increased workflow complexities for end users of additive manufacturing technology. Furthermore, since the orientations are specified outside of a CAD/CAM system, they are not linked with original object geometry causing quality assurance and workflow complexities when the original designs are modified, or when the orientation data is not provided to a different manufacturer for the same geometry.

The computation of optimal build orientations can be addressed, in general, by two types of methods. According to a “Type 1” approach, the system can analyze pre-selected candidate orientations and identify the best orientations among the pre-selected ones based on certain measures of manufacturing criteria. For Type 1 methods, the performance and quality depends on the sampling of direction space and computational efficiency for each candidate orientation. According to a “Type 2” approach, the system can use a dynamic on-the-fly search for orientations. Type 2 methods are time consuming due to the slow performance of the genetic algorithms that are typically used.

Disclosed embodiments include a new, third approach for enabling users of commercial CAD/CAM systems that suggests suitable build orientations, that can then be selected and fine-tuned appropriately, and stored and managed within the same system used to define part geometry and generate manufacturing operations.

Since the orientations are managed and archived in the design system, disclosed embodiments can provide a more complete 3D technical package for product lifecycle management of parts to be made with additive manufacturing.

Since part quality depends on build orientations, disclosed embodiments can enable improved quality assurance by allowing consistent fabrication of parts on several independent runs driven by the same PLM system.

Disclosed embodiments can enable an associative relationship between the design and its build orientation. So when the design changes, the orientation can be automatically updated.

Disclosed embodiments can enable a designer to estimate manufacturing cost during the design process in the CAD system itself.

Disclosed embodiments can allow the user to refine and edit the orientations after generation within the CAM environment itself.

Disclosed embodiments can enhance CAM by enabling creation of optimized slicing algorithms and toolpath processors.

According to disclosed embodiments, the orientations can be computed directly using solid model geometry, thereby avoiding the need for data or geometry translation, as well as improving geometric accuracy.

Disclosed embodiments address the aspects of build height and support structure volume.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. I/O adapter 122 can be connected to a 3D printer 150, which represents any additive manufacturing system under control of data processing system 100.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

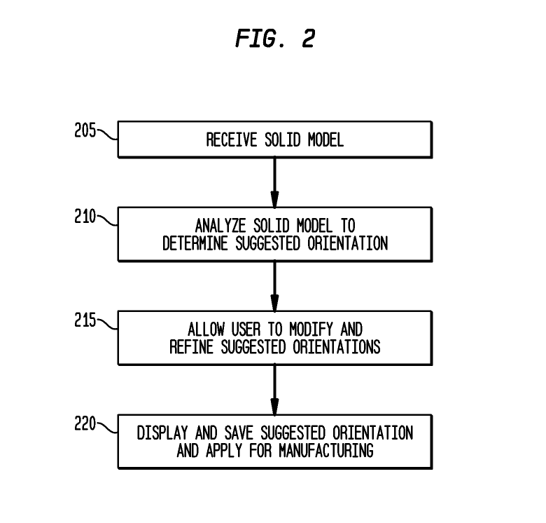

FIG. 2 illustrates a high-level workflow in accordance with disclosed embodiments. The system can receive a solid model (205). Receiving, as used herein, can include loading from storage, receiving from another device or process, receiving via an interaction with a user, or otherwise. The solid model can be a CAD/CAM model of a part to be manufactured, and can be represented in any CAD format. This step can include receiving a user input of what suggested orientation to determine, such as whether to find a suggested orientation for minimum build height or minimum support volume.

The system can analyze the solid model to determine suggested orientations (210). This can include generating and testing candidate orientations, as described below, and other processes as described herein.

The system can allow a user to modify and refine the suggested orientations (215). This can include displaying one or more suggested orientations to the user. This can include receiving a user selection of an orientation to manufacture or edit. This can include receiving user modifications to a selected orientation.

The system can save the orientation and apply them when manufacturing (220). This can include storing the selected orientation and any user modifications. This can include printing the solid model, in the selected orientation (with any user modifications applied), to produce a physical part.

Disclosed embodiments address the optimization of the orientation to reduce build time and support structure volume, and can address the optimization of the orientation with respect to reducing support structure volume or reducing build time. The “suggested” orientations discussed herein refer to the recommended optimal orientation determined by the system, and can be based on the user's selection of whether to search for minimum build height or minimum support volume.

In order to find the orientation with minimum support volume, a search is performed from a pool of candidate orientations, where support volume is computed for each orientation by performing geometric operations, such as by using the Parasolid geometric modeling kernel, to determine or compute the support volume for a support structure for each candidate orientation.

Disclosed embodiments include an automated method for determining candidate orientations.

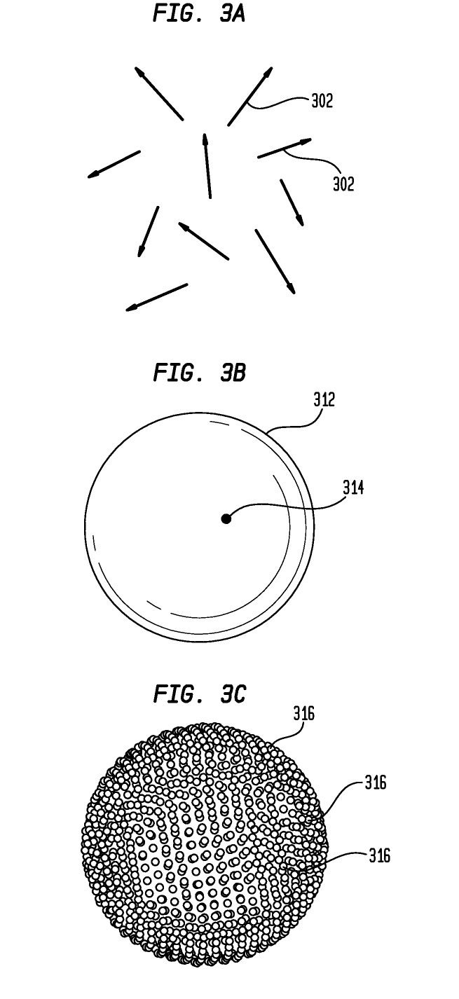

FIGS. 3A-3C illustrate candidate build orientation generation. FIG. 3A illustrates arbitrary build orientations 302 in the direction space. Of course, while this illustration is limited to two dimensions, the candidate orientations 302 are typically in three dimensions for a solid model. In these examples, assume that the orientation indicated by each arrow is to be “up” in the additive manufacturing process.

FIG. 3B illustrates any given orientation can be represented by a point on the unit sphere. A single point 314 on a unit sphere 312 can be used to represent an orientation corresponding to an arrow from the center of the sphere to the point 314.

FIG. 3C illustrates generated build orientations among which the suggested orientation will be searched. As part of analyzing the solid model to determine suggested orientations, the system can generate candidate orientations 316. The search space can be regarded as the unit sphere 312, where each point 314 on the sphere is associated with a candidate orientation 316 as shown in FIGS. 3A-3C.

Since it can be prohibitively exhaustive to search for the entire search space, i.e., the entire sphere surface, the system can instead use a number of samples on the unit sphere candidate orientations. Compared to the methods where only a few candidate orientations are considered, for example, the orientations normal to planar surface of the body or along the axis of cylindrical surface etc., this fashion of generating candidate orientations 316 does not depend on the specific geometry of input part and can be universally used. Usually a few hundred candidate directions are deemed as exhaustive and sufficient. A moderately fine resolution of sampling is sufficient since the users can later refine the orientations.

As an alternative approach to selecting a small number of orientations, the 3D convex hull of the solid part can be computed first. Then, the outward-facing normals to the faces of the convex hull can be used as the candidate orientations.

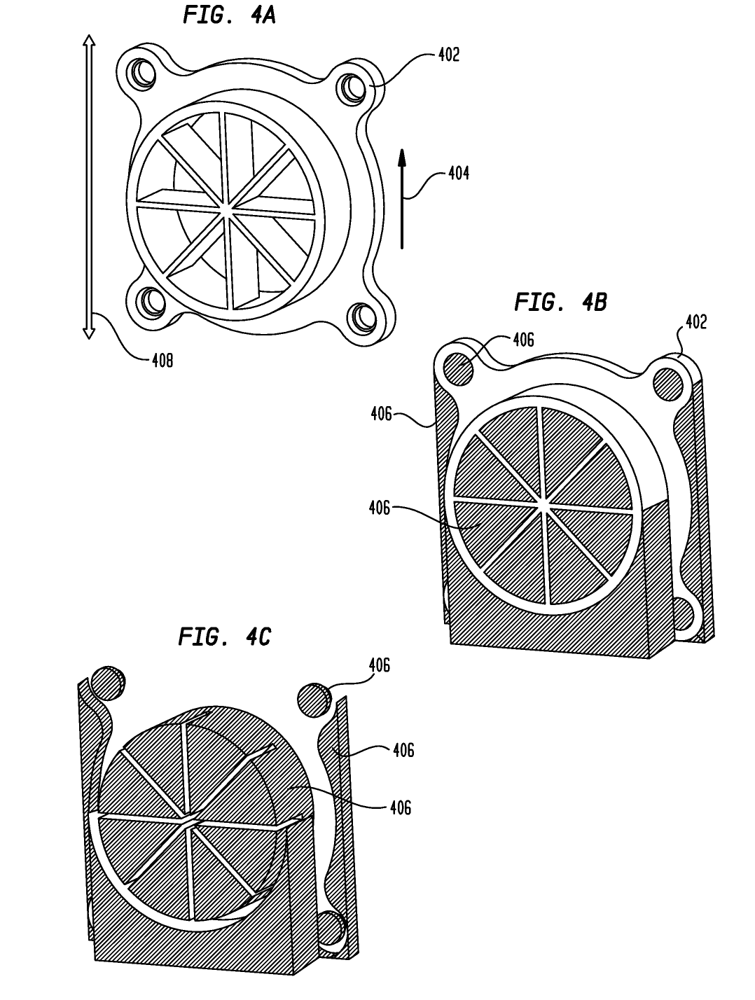

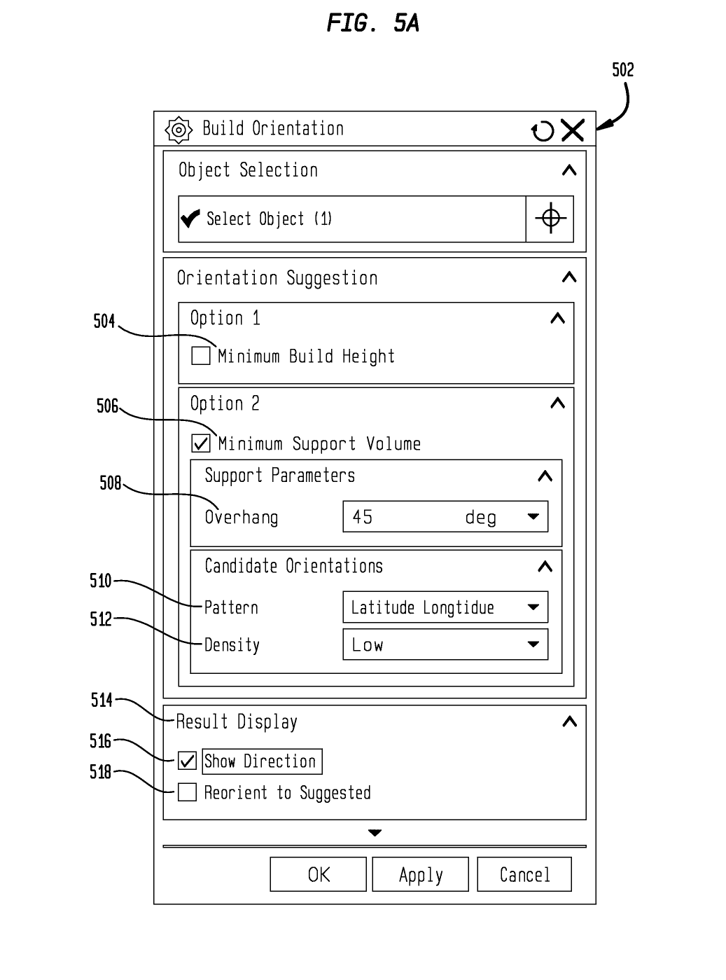

As part of analyzing the solid model to determine suggested orientations, the system can test the candidate orientations 316, in this case by estimating the required support volume in one or more of the candidate orientations 316. FIGS. 4A-4C illustrate estimated support volume generation using CAD techniques. FIG. 4A illustrates an input solid model 402 in a given build orientation 404. The arrow 404 indicates a build orientation of “up” with respect to the build plate. To properly create a physical part corresponding to solid model 402, support volume must be added in the form of a support structure 406 to support the otherwise-unsupported portions of solid model 402.

As part of analyzing the solid model to determine suggested orientations, the system can also determine the build height 408 of the solid model in a build orientation 404. The build time is directly proportional to build height. Therefore, the object height along a given build orientation can be used as a measure to optimize the orientation for build time. In order to find the orientation with minimum build height, the system can compute an orientated bounding box (or other bounding volume) of the solid model, and the axis along which the object has the least length can be selected as the build orientation that can minimize build time. By using the bounding box approach, the minimum build height orientation can be found more efficiently than analyzing build heights at each of the candidate orientations.

FIG. 4B illustrates a support structure 406 with the solid model 402. Support structure 406 must also be additively manufactured with solid model 402, in this orientation, in order for the corresponding physical part to be correctly printed. Note that the support structure 406 is not necessarily a single-piece structure; in this example support structure 406 represents all the different support-structure pieces that must be printed to correctly manufacture the physical part that corresponds to solid model 402.

FIG. 4C illustrates support structure 406, separate from solid model 402, to illustrate the support volume of material needed, in this orientation, to produce the physical part. Different orientations would naturally have different required support structures and therefore different required support volumes.

As part of analyzing the solid model to determine suggested orientations, the system can compute the support volume for each candidate orientation. To do so, the “downward” facing faces, in the each orientation, can be identified and extruded to the build platform plane, and Boolean operations can be used to obtain the actual support volume by removing the region intersecting with the input geometry itself FIGS. 4A-4C illustrate such an example with respect to solid model 402 and support structure 406.

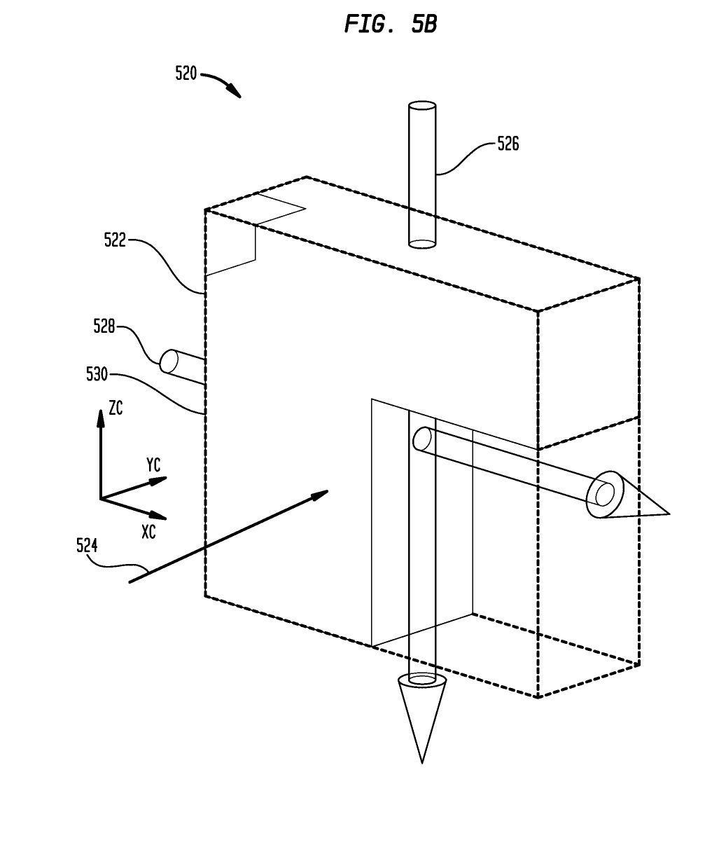

FIG. 5A illustrates a user interface 502 that allows the system to receive a user selection of finding a suggested orientation for minimum build height 504 or for minimum support volume 506. In the dialog, the parameters such as support angle 508, and candidate orientation sampling pattern 510 and density 512 can be adjusted. The user can also input whether to plot the suggested orientation and whether to reorient the part to that orientation.

For the minimum support volume 506, the user can also specify options such as the support structure angle under overhangs 508. The user can specify the pattern 510 of candidate orientations and the density (number) 512 of the candidate orientations to be generated.

The user can also specify how the suggested orientation result 514 is to be displayed. For example, the system can either display the suggested orientation direction 516 or can reorient the solid model 518 to the suggested orientation direction 516.

In the third step, all the support volume values of the candidate orientations are compared and sorted in descending order, and the one with the minimum support volume is shown to the user.

FIG. 5B illustrates an exemplary result output 520 for a solid model 522. In the dialog, the parameters such as support angle, and candidate orientation sampling pattern and density can be adjusted; also the user can decide whether to plot the suggested orientation and whether to reorient the part to that orientation. Two possible results are shown in this example. Arrow 524 indicates a suggested orientation (pointing “up” from the build plate) for a minimum build height. Arrow 526 indicates a suggested orientation (pointing “up” from the build plate) for a minimum support volume. Arrow 528 indicates an alternate suggested orientation (pointing “up” from the build plate) for a minimum build height if the manufacturing requirements (such as the size of the build plate/area) do not permit the build orientation indicated by arrow 524. The dotted lines indicate a bounding box 530 that can be used as described above to determine the shortest axis for a suggested orientation.

The following papers and articles are incorporated by reference: Solid Freeform Fabrication Symposium, pp. 259-269, 1994; Rapid Prototyping Journal, 1(4). pp. 12-23, 1995; Proceedings of the Solid Freeform Fabrication Symposium, 6, pp. 362-368, 1995; Transactions-North American Manufacturing Research Institution of SME, pp. 319-324, 1995; Rapid Prototyping Journal, 3(3). pp. 76-88, 1997; Computer-Aided Design, 30(5), pp. 343-356, 1998; The International Journal of Advanced Manufacturing Technology, 14(4). pp. 247-254, 1998; Rapid Prototyping Journal, 5(2). pp. 54-60, 1999; The International Journal of Advanced Manufacturing Technology, 15(9). pp. 674-682, 1999; Intelligent Systems and Smart Manufacturing, pp. 16-26, 2000; The International Journal of Advanced Manufacturing Technology, 16(3), pp. 162-168, 2000; Journal of Materials Processing Technology, 112(2). pp. 236-243, 2001; The International Journal of Advanced Manufacturing Technology, 18(5). pp. 313-322, 2001; The International Journal of Advanced Manufacturing Technology, 19(3). pp. 209-216, 2002; Journal of Materials Processing Technology, 130, pp. 378-383, 2002; The International Journal of Advanced Manufacturing Technology, 28(3-4). pp. 307-313, 2006; Proceedings of the Institution of Mechanical Engineers, Part B: Journal of Engineering Manufacture, 221(7). pp. 1209-1219, 2007; International Journal of Production Research, 42(19), pp. 4069-4089, 2004; International Journal of Production Research, 43(13). pp. 2709-2724, 2005; Computer-Aided Design and Applications, 2(1-4). pp. 319-328, 2005; Robotics and Computer-Integrated Manufacturing, 22(1). pp. 69-80, 2007; WSEAS Transactions on Applied and Theoretical Mechanics, 4(4). pp. 185-194, 2009; The International Journal of Advanced Manufacturing Technology, 45(7-8). pp. 714-730, 2009; Industrial Engineering and Engineering Management (IEEM), 2010 IEEE International Conference, pp. 281-285, 2010; Journal of Manufacturing Systems, 31(4). pp. 395-402, 2012; The International Journal of Advanced Manufacturing Technology, 67(1-4), pp. 733-743, 2013; and The International Journal of Advanced Manufacturing Technology, 69(5-8). pp. 1819-1831, 2013.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method for product data management, the method performed by a data processing system and comprising:
receiving a solid model;
analyzing the solid model to determine a suggested orientation that minimizes a build height or minimizes a support volume; and
displaying and saving the suggested orientation.

2. The method of claim 1, wherein the data processing system also applies the orientations during a manufacturing process.

3. The method of claim 1, wherein the data processing system also generates candidate orientations.

4. The method of claim 3, wherein the data processing system also computes a support volume for a support structure for each candidate orientation.

5. The method of claim 4, wherein the data processing system compares and sorts the support volumes for the candidate orientations and uses the candidate orientation with the least support volume as the suggested orientation that minimizes support volume.

6. The method of claim 1, wherein the displayed suggested orientation has a minimum support volume among a pool of candidate orientations.

7. The method of claim 1, wherein the data processing system computes a bounding box of the solid model and uses an axis of the bounding box with a least length as the suggested orientation that minimizes build height.

8. A data processing system comprising:
a processor; and
an accessible memory, the data processing system particularly configured to receive a solid model;
analyze the solid model to determine a suggested orientation that minimizes a build height or minimizes a support volume; and
display and save the suggested orientation.

9. The data processing system of claim 8, wherein the data processing system also applies the orientations during a manufacturing process.

10. The data processing system of claim 8, wherein the data processing system also generates candidate orientations.

11. The data processing system of claim 10, wherein the data processing system also computes a support volume for a support structure for each candidate orientation.

12. The data processing system of claim 11, wherein the data processing system compares and sorts the support volumes for the candidate orientations and uses the candidate orientation with the least support volume as the suggested orientation that minimizes support volume.

13. The data processing system of claim 8, wherein the displayed suggested orientation has a minimum support volume among a pool of candidate orientations.

14. The data processing system of claim 8, wherein the data processing system computes a bounding box of the solid model and uses an axis of the bounding box with a least length as the suggested orientation that minimizes build height.

15. A non-transitory computer-readable medium encoded with executable instructions that, when executed, cause one or more data processing systems to:
receive a solid model;
analyze the solid model to determine a suggested orientation that minimizes a build height or minimizes a support volume; and
display and save the suggested orientation.

16. The computer-readable medium of claim 15, wherein the data processing system also applies the orientations during a manufacturing process.

17. The computer-readable medium of claim 15, wherein the data processing system also generates candidate orientations.

18. The computer-readable medium of claim 17, wherein the data processing system also computes a support volume for a support structure for each candidate orientation.

19. The computer-readable medium of claim 18, wherein the data processing system compares and sorts the support volumes for the candidate orientations and uses the candidate orientation with the least support volume as the suggested orientation that minimizes support volume.

20. The computer-readable medium of claim 15, wherein the data processing system computes a bounding box of the solid model and uses an axis of the bounding box with a least length as the suggested orientation that minimizes build height.
